(19) United States
(12) Patent Application Publication
(10) Pub. No.: US 2006/0209362 A1
(43) Pub. Date: Sep. 21, 2006

(54) Scanner system and scanned data storing method

(75) Inventors: Yoshiko Suenaga, Kanagawa-ken (JP); Hiroki Miyachi, Kanagawa-ken (JP); Kouichi Mase, Chiba-Ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/289,948

(22) Filed: Nov. 29, 2005

(30) Foreign Application Priority Data
Mar. 15, 2005 (JP) 2005-072812

(51) Int. Cl. H04N 1/04

(52) U.S. Cl. 358/474; 358/1.15

(57) ABSTRACT

According to the present invention, scanned data obtained by scanning the same original under different conditions is held such that the optimum data can be extracted according to the application. A scanner system includes: an operation unit for accepting an input operation; a display unit for showing information in a visual form; a scanner unit for scanning an original under each scanning condition specified from preset different scanning conditions to generate image information every specified scanning condition; a scanning condition management unit for managing scanning condition information including at least one scanning condition; a data display management unit for retrieving image information satisfying a specified scanning condition from the stored image information to extract the retrieved image information; and a control unit for controlling the above respective units.

### BACKGROUND OF THE INVENTION

1. Field of the Invention

The present invention relates to scanner systems and scanned data storing methods and, more particularly, to a scanner system and a scanned data storing method for scanning the same original under different conditions to store scanned data every condition.

2. Description of the Related Art

Japanese Unexamined Patent Application Publication No. 2004-234261 discloses a scanner system and a scanned data storing method. According to the known system and method, different scanning conditions are selected, pre-scanning is then performed, and an image corresponding to captured image data is subjected to optical character recognition (hereinafter, abbreviated to OCR) processing, thus automatically finding a scanning condition with a high recognition rate.

The above-mentioned system and method note only the recognition rate of OCR to optimize the scanning condition. Generally, however, the optimum scanning condition varies depending on the application of scanned image data. Therefore, when the recognition rate of OCR is high, the optimum scanning condition is not necessarily obtained.

Even when the same original is subjected to OCR processing, the scanning condition varies depending on the application of scanned data. According to the known scanner system, therefore, in order to use scanned data of the same original for different applications, the scanning condition has to be changed every scanning in accordance with the characteristics of the original and the application of scanned data. Disadvantageously, the wider the applications of scanned data are, the more time and labor scanning requires.

### SUMMARY OF THE INVENTION

The present invention is made to overcome the above-mentioned disadvantages and it is an object of the present invention to provide a scanner system and a scanned data storing method for holding data captured by scanning the same original under different conditions such that the optimum data according to the application is extractable upon using the data.

According to the present invention, there is provided a scanner system including: an operation unit for accepting an input operation; a display unit for showing information in a visual form; a scanner unit for scanning an original under each scanning condition specified from preset different scanning conditions to generate image information every specified scanning condition; a scanning condition management unit for managing scanning condition information including at least one scanning condition; a data display management unit for retrieving image information satisfying a specified scanning condition from the stored image information to extract the retrieved image information; and a control unit for controlling the operation unit, the display unit, the scanner unit, the scanning condition management unit, and the data display management unit.

According to the present invention, there is provided a scanned data storing method including the steps of: obtaining at least one scanning condition; scanning under each scanning condition; and storing an image, captured by scanning under each scanning condition, in association with the corresponding scanning condition.

According to the scanner system and the scanned data storing method of the present invention, scanned data obtained by scanning the same original under different conditions is held, so that the optimum data according to the application can be extracted upon using the data.

### BRIEF DESCRIPTION OF THE DRAWINGS

FIG. 1 is a schematic block diagram of the functional structure of a scanner system according to an embodiment of the present invention; and

FIG. 2 is a flowchart of a scanning process executed by the scanner system according to the embodiment of the present invention.

### DESCRIPTION OF THE PREFERRED EMBODIMENTS

A scanner system and a scanned data storing method according to the present invention will now be described with reference to the attached drawings.

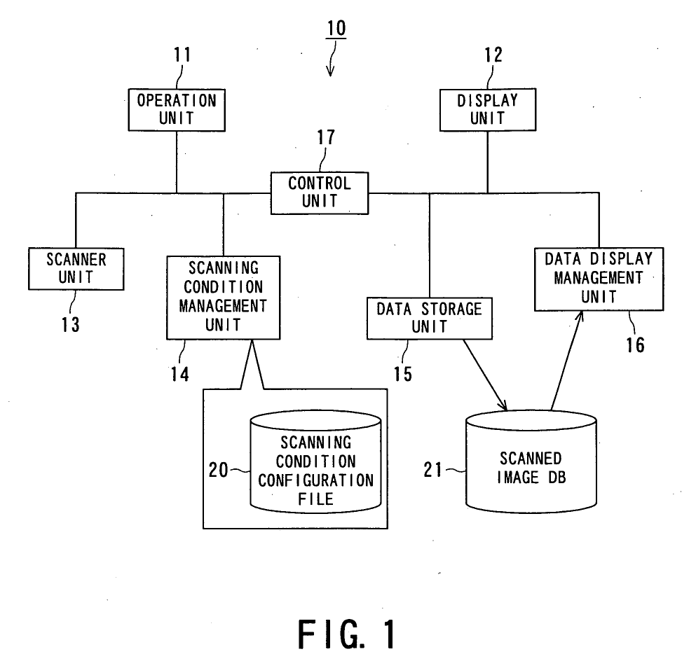

FIG. 1 is a schematic block diagram of the functional structure of a scanner system 10 according to an embodiment of the present invention.

Referring to FIG. 1, the scanner system 10 includes: an operation unit 11 for accepting an input operation, such as a scanning-condition setting input, from a user; a display unit 12 for showing information to the user in a visual form; a scanner unit 13 for scanning an original to generate image information; a scanning condition management unit 14 for managing information regarding at least one scanning condition to be used upon scanning (hereinafter, referred to as scanning condition information); a data storage unit 15 for storing the generated image information such that the image information is associated with the corresponding scanning condition used upon generating the image information; a data display management unit 16 for retrieving image information which satisfies a specified condition from the stored image information to extract the retrieved image information; and a control unit 17 for controlling the above units 11 to 16.

The operation unit 11 has a function of accepting a user input operation. Information regarding the details of the input operation accepted by the operation unit 11 is transmitted as input operation information to the control unit 17.

The display unit 12 has a function of receiving display information from the control unit 17 to display an indication based on the received display information. In other words, when receiving display information, the display unit 12 can display an indication based on the received display information.

The operation unit 11 and the display unit 12 are not necessarily arranged as separate components in the actual system. The units 11 and 12 may be provided as an integrated operation/display unit.

The scanner unit 13 has a function of scanning an original (the surface of a sheet) to generate image information. When generating image information, the scanner unit 13 can transmit the generated image information to the control unit 17.

In addition, the scanner unit 13 obtains scanning condition information before scanning and then scans on the basis of the obtained scanning condition information. The scanner unit 13 receives the scanning condition information from the control unit 17.

The scanning condition management unit 14 can obtain the scanning condition information that is preset. The scanning condition information includes scan configuration information regarding set parameter values, i.e., the type of an original, e.g., text or a photo, gray scales, a background correction value, sharpness, and a color correction value. In other words, each scanning condition is defined by a combination of those set values.

The scanning condition management unit 14 has a function of assigning a name (hereinafter, referred to as a scan profile name) to each unity, serving as a combination of set values, to manage the unity. In the scanner system 10, therefore, scan profile names related to various applications, e.g., “for white background text” and “for tampering detection”, can be assigned to respective conditions and the related scan profile names can be previously registered. In other words, the scanning condition management unit 14 can manage the scanning condition information including different scanning conditions.

On the other hand, the scanning condition information can be obtained with reference to a scanning-condition configuration file 20 in which the scanning condition information is recorded. The scanning-condition configuration file 20 is stored in an electronic information recording area (hereinafter, referred to as internal recording area) which is readable by the scanning condition management unit 14. For example, the electronic information recording area is provided in the scanning condition management unit 14 such as a unit provided in the scanner system 10. Note that the electronic information recording area is not necessarily provided in the scanner system 10. The electronic information recording area (hereinafter, referred to as external recording area and the external recording area is not shown) may be provided in the external recording device which is readable by the scanning condition management unit 14.

The data storage unit 15 has a function of associating image information generated by the scanner unit 13 with a scanning condition used upon generating the image information to store the image information in the internal recording area of the scanner system 10 or the external recording area. For example, the data storage unit 15 records image information generated by the scanner unit 13 in the internal recording area in association with the corresponding scanning condition used upon generating the image information. Stored image information can be used as a scanned image database (hereinafter, abbreviated to a scanned image DB) 21.

After that, the data display management unit 16 reads the image information generated by the scanner unit 13 and uses the information. Therefore, the image information has to be stored in the electronic information recording area, which is recordable by the data storage unit 15 and is also readable by the data display management unit 16. In other words, image information generated by the scanner unit 13 is stored in association with the corresponding scanning condition in the internal recording area of the scanner system 10 or the external recording area, which is recordable by the data storage unit 15 and, moreover, is readable by the data display management unit 16.

The data display management unit 16 has a function (scanned image retrieving function) of retrieving (searching) image information satisfying a specified condition from the image information stored in the scanned image DB 21 using a key as the specified condition, which is input from the operation unit 11. Accordingly, the data display management unit 16 can retrieve (search) image information satisfying the specified condition supplied from the operation unit 11, from the image information stored in the scanned image DB 21. Then, the data display management unit 16 transmits information regarding the retrieval result (hereinafter, referred to as retrieval result information) to the control unit 17.

The control unit 17 has a function of controlling the operation unit 11, the display unit 12, the scanner unit 13, the scanning condition management unit 14, the data storage unit 15, and the data display management unit 16 and is capable of transmitting and receiving information to/from the units 11 to 16.

More specifically, the control unit 17 receives input operation information regarding the details of a user input operation from the operation unit 11 and controls the operation unit 11, the display unit 12, the scanner unit 13, the scanning condition management unit 14, the data storage unit 15, and the data display management unit 16 in accordance with the details of the input operation. The control unit 17 can allow at least one of the units to execute necessary processing corresponding to the details of the input operation.

In addition, the control unit 17 can receive scanning condition information obtained by the scanning condition management unit 14 and then transmit the received information to the scanner unit 13.

Further, the control unit 17 receives image information generated by the scanner unit 13 and the scanning condition information obtained by the scanning condition management unit 14 and then transmits the received information to the data storage unit 15.

Furthermore, the control unit 17 can receive retrieval result information, serving as the result of retrieving image information satisfying a specified condition through the data display management unit 16, generate display information representing the retrieval result, and then transmit the display information to the display unit 12.

According to the scanner system 10 with the above-mentioned structure, the scanning condition management unit 14 obtains information regarding at least one scanning condition specified by the user and the scanner unit 13 scans the same original under each specified condition, so that a scanned image (image information) can be obtained every scanning condition. In addition, the data storage unit 15 stores the obtained image information in association with the corresponding specified scanning condition. Consequently, upon using image information, the data display management unit 16 can extract the optimum data from the stored image information according to the application.

The scanner system 10 may include an interface (I/F) unit for connecting to an external device. In the event that the scanner system 10 includes I/F unit, the scanner system 10 may be connected to a server for storing electronic data, another OCR processing unit, and/or a management computer for managing a plurality of OCR processing unit, thus providing a new function.

In the scanner system 10, as an additional function of the scanned image retrieving function, the data display management unit 16 may have a function of, when pieces of image information satisfy a specified condition, assigning priorities to the respective pieces of image information based on preset criteria.

Since the data display management unit 16 has the above-mentioned function of assigning the priorities to pieces of image information to be displayed, even when pieces of image information satisfying a specified condition, image information with higher priority, i.e., image information with higher need can be displayed on a priority basis. In addition, the pieces of image information may be listed and displayed in order of decreasing priority. When the user specifies a piece of image information in the displayed list, an image satisfying the specified image information can be displayed.

A scanned data storing method according to the present invention will now be described.

The scanned data storing method according to the present invention can be realized by executing a scanning process through a scanner system, such as the scanner system 10.

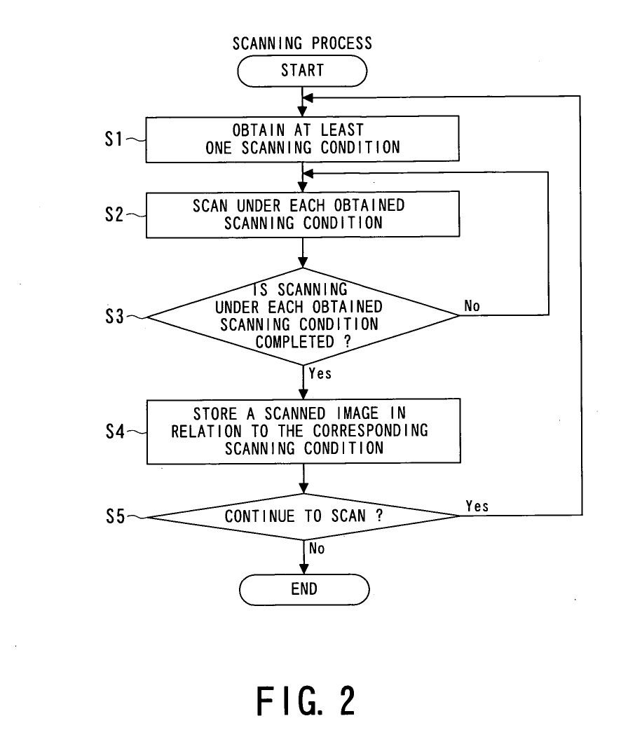

FIG. 2 shows a flowchart of the scanning process executed by the scanner system according to the present invention.

Referring to FIG. 2, the scanning process includes a scanning condition obtaining step (step S1) of obtaining at least one scanning condition, a scanning step (step 2) of scanning under each obtained scanning condition, a scan completion confirming step (step S3) of confirming whether scanning under each obtained scanning condition is completed, a scanned data storing step (step S4) of storing a scanned image in relation to the corresponding scanning condition, and a scan continuation confirming step (step S5) of confirming whether scanning is continued.

The operation unit 11 accepts an input operation indicating that at least one scanning condition is specified and the start of scanning is requested and transmits information (input operation information) regarding the input operation to the control unit 17. When the control unit 17 receives the input operation information transmitted from the operation unit 11, the scanning process is started (START).

According to the scanning process, at first, in step S1, the scanning condition obtaining step is executed. In step S1, the control unit 17 which has received the input operation information generates control information for controlling the scanning condition management unit 14 so as to obtain the specified scanning conditions including at least one scanning condition, e.g., a plurality of scanning conditions. Then, the control unit 17 transmits the control information to the scanning condition management unit 14. When the scanning condition management unit 14 receives the control information, the scanning condition management unit 14 obtains information (scanning condition information) in relation to scanning condition by referring to the scanning-condition configuration file 20 in which the scanning-conditions are recorded.

Each scanning condition is specified by specifying a combination of various set values or a scan profile name. The scanning condition management unit 14 obtains the scanning condition information. As a result of obtaining the scanning condition information, the scanning condition management unit 14 can obtain the scanning conditions. The scanning condition management unit 14 transmits the obtained scanning condition information to the control unit 17. When the control unit 17 obtains the scanning condition information, step S1, i.e., the scanning condition obtaining step completes. Then, the process proceeds from step S1 to step S2.

In step S2, the scanning step is executed. In the scanning step, the scanner unit 13 receives the scanning conditions, obtained in the scanning condition obtaining step (step S1), from the control unit 17 and scans a currently set object to be scanned under each scanning condition. As a result of scanning under each scanning condition, the scanner unit 13 obtains image information corresponding to every scanning condition. Upon completion of obtaining image information corresponding to every scanning condition, the process proceeds from step S2 to step S3.

In step S3, the scan completion confirming step is executed. In the scan completion confirming step, the control unit 17 confirms whether the scanning under each scanning condition is completed or not. In the event of scanning under each scanning condition is completed (YES in step S3), the control unit 17 generates control information for controlling the data storage unit 15 so as to store each scanned image in association with the corresponding scanning condition. Then, the control unit 17 transmits the control information to the data storage unit 15. When the data storage unit 15 receives the control information, the scan completion confirming step completes. The process proceeds from step S3 to step S4.

In step S4, the scanned data storing step is executed. In the scanned data storing step, the data storage unit 15 stores each scanned image (image information), obtained in the scanning step (step S2), in association with the corresponding scanning condition (scanning condition information) in the scanned image DB 21. Upon completion of storing each scanned image in the scanned image DB 21, the process proceeds from step S4 to step S5.

In step S5, the scan continuation confirming step is executed. In the scan continuation confirming step, the control unit 17 generates display information so as to check whether scanning is continued or not and then transmits the display information for checking scan continuation to the display unit 12. When the display unit 12 receives the display information, the display unit 12 displays an indication to check whether scanning is continued or not, i.e., prompts the user to check whether scanning is continued or not.

After the display unit 12 displays an indication to check whether scanning is continued, when the operation unit 11 accepts an input operation indicating that scanning is not continued (NO in step S5), the scan continuation confirming step completes. Then, the scanning process completes (END).

On the other hand, if it is confirmed in the scan completion confirming step that scanning under each scanning condition is not completed (NO in step S3), the process is returned to step S2, thus executing step S2 and subsequent steps.

In the scan continuation confirming step, if the operation unit 11 accepts an input operation indicating that scanning is continued (YES in step S5), the process is returned to step S1, thus executing step S1 and subsequent steps.

Note that the scanning process may not include the scan continuation confirming step which is executed for the convenience of the user. In other words, the scan continuation confirming step is not necessarily executed in order to realize the scanned data storing method according to the present invention.

According to the above-mentioned scanned data storing method, scanned data obtained by scanning the same original under different conditions can be stored. Accordingly, it is unnecessary to change a scanning condition every scanning according to the characteristics of an original and the application of scanned data. In comparison to the known scanned data storing method, the wider the applications of scanned data are, the more time and labor the scanning process saves.

In addition, since scanned data obtained by scanning the same original under different conditions can be stored, the stored data can be referred according to the application upon using the scanned data.

A case where obtained scanned data is referred in the scanner system according to the present invention will now be described.

For example, in the event that obtained scanned data is referred in the scanner system 10 according to the embodiment of the present invention, the operation unit 11 accepts an input operation to specify a scanning condition to be used in scanning. When a combination of various set values or a scan profile name is specified, specifying a scanning condition is completed.

When the scanning condition is specified, the operation unit 11 transmits input operation information indicating the scanning condition to be used in scanning to the control unit 17. The control unit 17 transmits the received scanning condition to the data display management unit 16.

On the basis of the scanning condition received from the control unit 17, the data display management unit 16 retrieves (searches) a scanned image (image information) which satisfies the received scanning condition from image information stored in the scanned image DB 21. Upon completion of obtaining retrieved information as the retrieval result, the data display management unit 16 transmits information indicating the retrieval result to the control unit 17. The control unit 17 generates display information to display the retrieval result information and transmits the display information to the display unit 12.

Upon completion of receiving the display information to display the retrieval result information, the display unit 12 can display the retrieval result on the basis of the retrieval result information. The data display management unit 16 may have a function of assigning priorities to pieces of image information to be displayed. Accordingly, image information with higher priority, i.e., image information with higher need can be displayed on a priority basis.

As mentioned above, since the scanner system 10 can store scanned data obtained by scanning the same original under different conditions, a scanned image suitable for the application can be retrieved and referred. For example, to detect a scanned image for the purpose of checking whether an original has been tampered with or not, a scanning condition in which the gray scale of the background is closer to black is preset as a scanning condition “for tampering detection”. A scanned image stored under the scanning condition “for tampering detection” is retrieved and referred. Thus, although a portion (hereinafter, referred to as corrected portion) covered with correction fluid (white liquid for correcting), a correction tape (white tape for correcting) or the like serving as correction means is hardly detected in a scanned image obtained under a general scanning condition “for white background text”, such a corrected portion can be clearly recognized according to the present invention.

As mentioned above, according to the scanner system and scanned data storing method of the present invention, scanned data obtained by scanning the same original under different conditions is stored, so that the optimum data according to the application can be extracted upon using the scanned data.

What is claimed is:

1. A scanner system comprising:
an operation unit for accepting an input operation;
a display unit for showing information in a visual form;
a scanner unit for scanning an original under each scanning condition specified from preset different scanning conditions to generate image information every specified scanning condition;
a scanning condition management unit for managing scanning condition information including at least one scanning condition;
a data display management unit for retrieving image information satisfying a specified scanning condition from the stored image information to extract the retrieved image information; and
a control unit for controlling the operation unit, the display unit, the scanner unit, the scanning condition management unit and the data display management unit.

2. The system according to claim 1, wherein said data storage unit for storing the generated image information in association with the corresponding scanning condition.

3. The system according to claim 1, wherein, in a case that a plurality of pieces of image information satisfy the specified scanning condition, said data display management unit is configured to assign priorities to respective pieces of image information to be displayed in the display unit based on preset criteria.

4. The system according to claim 1, wherein said scanning condition information includes scanning conditions set for respective applications of scanned data.

5. The system according to claim 1, wherein when retrieving image information satisfying the specified scanning condition, said data display management unit obtains as the scanning condition including set scan parameter values including at least one of an original type, gray scales, a background correction value, sharpness and a color correction value.

6. A scanned data storing method comprising the steps of:
obtaining at least one scanning condition;
scanning under each scanning condition; and
storing an image, captured by scanning under each scanning condition, in association with the corresponding scanning condition.
